(19) United States
(12) Patent Application Publication
(10) Pub. No.: US 2023/0125201 A1
(43) Pub. Date: Apr. 27, 2023

(54) PORTABLE APPARATUS, MATERIALS AND SENSORS FOR RAPID DETECTION OF PER AND POLY-FLUOROALKYL SUBSTANCES (PFAS)

(71) Applicants: Emanuela Silvana Andreescu, Potsdam, NY (US); Abd Ur Rehman, Potsdam, NY (US); Daniel Andreescu, Potsdam, NY (US)

(72) Inventors: Emanuela Silvana Andreescu, Potsdam, NY (US); Abd Ur Rehman, Potsdam, NY (US); Daniel Andreescu, Potsdam, NY (US)

(73) Assignee: CLARKSON UNIVERSITY, POTSDAM, NY (US)

(21) Appl. No.: 17/973,143

(22) Filed: Oct. 25, 2022

Related U.S. Application Data
(60) Provisional application No. 63/271,271, filed on Oct. 25, 2021.

(51) Int. Cl. G01N 21/78; G01N 27/48

(52) U.S. Cl. CPC G01N 21/78; G01N 27/48

(57) ABSTRACT

A method and sensing system for the determination per and poly-fluoroalkyl substances (PFASs) is disclosed, wherein the probe is based on measurement of the redox activity of a redox indicator. The method includes adding a PFAS compound to an indicator solution, gel, 3D printed object, electrode or a sensing surface containing and measuring the change in the indicator signal as a function of PFAS concentration. Further provided is a portable sensor for rapid monitoring of the presence and PFAS concentrations. The present invention includes deposition of the indicator component within a method, assay, apparatus and sensing platform. Further provided is a composite electrode and sensor with binding and signaling activity for a broad range of PFAS, as well as printing ink compositions that incorporate the redox indicator.

### CROSS-REFERENCE TO RELATED APPLICATION

This application claims priority to U.S. Provisional Patent Application Ser. No. 63/271,271, filed on Oct. 25, 2021 and entitled “PORTABLE APPARATUS, MATERIALS AND SENSORS FOR RAPID DETECTION OF PER AND POLY-FLUOROALKYL SUBSTANCES (PFAS),” the entire disclosure of which is incorporated herein by reference.

### GOVERNMENT FUNDING

N/A

### FIELD OF THE INVENTION

The present disclosure is directed generally to components, methods, sensors and analytical devices for rapid detection of PFAS. More specifically, the disclosure relates to the use of redox indicators to fabricate assays, sensors and apparatus for the detection of PFAS substances and to their application in a variety of fields including clinical diagnosis, environmental and food.

### BACKGROUND

Per and polyfluoroalkyl substances (PFAS) are emerging environmental pollutants used in many commercial products and applications such as polymers, fire-retarding foams, lubricants, cookware and food packaging. PFAS pose significant threats to the environment and human health due to their high stability, toxicity and ability to bioaccumulate. Therefore the ability to assess environmental contamination is essential for effective monitoring and remediation. Currently available methods include gas or liquid chromatography (GC or LC) tandem mass spectrometry (MS/MS) that are expensive, time consuming and require samples to be sent to a centralized laboratory for analysis. While these methods are selective and quantitative, field analysis is currently not possible due to lack of adequate field-deployable techniques. Sensitive sensors and methods for detection of the broad spectrum of PFAS can provide an estimation of their overall distribution, potential exposure and treatment efficacy.

Due to their widespread use, environmental persistence and potential harmful impacts, the EPA-recommended level for PFAS is 70 parts per trillion (70 ng/L or ppt), while some states, e.g. NY State, have adopted new standards for maximum contaminant levels (MCLs) of 10 parts per trillion (10 ppt). EPA advisory limits are 0.04 ppt for PFOA, 0.02 ppt for PFOS and 10 ppt for GenX. Measuring PFAS at such low concentrations require ultrasensitive methods for their detection. Conventional methods involve coupling of chromatography with solid-phase extraction (SPE), LC and MS, which enable pre-concentration, separation and detection. Although these measurements are sensitive and precise, such a complex set up is not suitable for onsite monitoring and can only be done by skilled operators in state-of-the-art analytical testing facilities. At present only few laboratories are equipped with suitable instrumentation to perform PFAS analysis. Moreover, the high cost per sample (200-800$, depending on the sample type) significantly hinders the available testing capabilities. New analytical methods are needed to expand tools for monitoring PFAS.

Several approaches to detect PFAS have been reported. These prior works use Molecularly Imprinted Polymers (MIPs) as receptors deposited on a working electrode to capture a selected PFAS, followed by measuring the blocking of the MIPs cavity using a soluble redox dye, added in solution. This method was demonstrated for the determination of perfluorooctane sulfonate (PFOS) with a chemically modified MIP-coated electrode prepared from poly(o-phenylenediamine) (o-PD) and with ferocenecarboxylic acid (FcCOOH) as redox probe (Paolo UGO, et al, 2018,). The method consists of several steps: i) mixing of template molecules with monomer and a cross-linker and electropolymerization to form a polymer network with the immobilized target, ii) extraction of the target, iii) binding of the analyte into the MIP cavity, (IV) using a soluble electrochemical redox probe to measure the removal and binding of the target. In previously developed tests, the soluble redox compound, e.g. the FcCOOH, is used in solution to indirectly quantify binding of PFAS analyte into the MIP's cavity (Karimiam et al., ACS Sensors, 2018; Kazemi et al., Analytical Chemistry, 2020). Kazemi et al have shown that other molecules, such as chloride and humic acid interfere with measurements and therefore the method lacked specificity towards PFAS (Karemi et al., Analytical Chemistry, 2020). In the new sensor, redox materials are immobilized onto an electrode surface. The immobilized redox material reacts with PFAS, changing its redox status and directly quantifying PFAS in a single step process. The new method does not involve templating or extracting molecules; the redox probes are affixed onto an electrode and the signal is generated by measuring the current of the immobilized probe interacting with PFAS. The new strategy is applicable to the broad range of PFAS compounds, unlike the MIPs-based detection that measures a single type of PFAS molecule, specifically those with a size that matches the geometrically of the MIP's cavity.

Several types of materials for capture of PFAS that can be used for sorption and detection have been reported (Motkuri et al, 2020 US20200369536A1, Cheng et al, ACS. Appl. Mater. Interfaces, 2020). These include porous metal organic frameworks (MOFs), covalent organic frameworks (COFs) or covalent organic polymers (COPs). In previous work, these material sorbents have been used for capture and remediation in a fluidic platform, which ahs also shoed that it can be used to detect sorbent-PFOS interactions with electrochemical impedance spectra (EIS). In the new design, PFAS is measured with redox materials immobilized or printed or deposited on electrodes and detection is done by measuring PFAS binding to the redox indicator using methods such as electrochemical differential pulse voltammetry (DPV).

Color based methods for PFAS detection have been reported by measuring changes in spectral features of colloidal nanoparticles (NPs) upon interaction with PFAS, or PFAS-induced aggregation, or by measuring changes in UV-Vis absorption of soluble dyes upon PFAS binding. Most reported strategies involve the use of gold (Au)NPs with measurements of changes in their surface properties, followed by aggregation, which induces a subsequent color change upon interaction with PFASs (Takayose et al, Analytical letters, 2012; Niu et al, Analytical Chemistry, 2014). In previous methods, the NPs or the dyes have been used in solution and the methods lacks sensitivity, most reporting detection limits in the ppm concentration range, far from the EPA concentration range. Additional the method has shown cross reactivity from heavy metals, anions, cations and surfactants. In the new method, the redox compound is immobilized or printed on an electrode platform and detection limits reach values down to low ppb and ppt ranges.

The relevant art is described in further detail in the following references, all of which are hereby incorporated by reference: Paolo UGO, Najmeh Karimian, Angela Maria Stortini, Ligia Maria Moretto, WO2018162611A1, (Publication date 13 Sep. 2018), New molecularly-imprinted electrochemical sensors for perfluorooctansulfonate and analytical methods based thereon; Radha K. Motkuri, Sayandev Chatterjee, Dushyant Barpaga, Bernard P. McGrail, US20200369536A1 (Publication date: Nov. 26, 2020, Composition and method for capture and degradation of PFAS; Sayandev Chatterjee, Radha K. Motkuri, Sagnik Basuray, Yu Hsan Cheng, Dushyant Barpaga, Bernard P. McGrail, US 20220252536 (Publication date: Aug. 11, 2022, Fluidic Impedance platform for In-situ detection and quantification of PFAS in groundwater; N. Karimian, A. M. Stortini, L. M. Moretto, C. Costantino, S. Bogialli, P. Ugo, Electrochemosensor for Trace Analysis of Perfluorooctanesulfonate in Water Based on a Molecularly Imprinted Poly(o-phenylenediamine) Polymer, ACS Sensors, 3(2018) 1291; R. Kazemi, E. I. Potts, J. E. Dick, Quantifying Interferent Effects on Molecularly Imprinted Polymer Sensors for Per- and Polyfluoroalkyl Substances (PFAS), Analytical chemistry, 92(2020) 10597-605; M. Takayose, K. Akamatsu, H. Nawafune, T. Murashima, J. Matsui, Colorimetric detection of perfluorooctanoic acid (PFOA) utilizing polystyrene-modified gold nanoparticles, Analytical letters, 45(2012) 2856-64; H. Niu, S. Wang, Z. Zhou, Y. Ma, X. Ma, Y. Cai, Sensitive colorimetric visualization of perfluorinated compounds using poly (ethylene glycol) and perfluorinated thiols modified gold nanoparticles, Analytical chemistry, 86(2014) 4170-7; Y. H. Cheng, D. Barpaga, J. A. Soltis, V. Shutthanandan, R. Kargupta, K. S. Han, B. P. McGrail, R. K. Motkuri, S. Basuray, S. Chatterjee, Metal-Organic Framework-Based Microfluidic Impedance Sensor Platform for Ultrasensitive Detection of Perfluorooctanesulfonate, ACS. Applied Mater. Interfaces, 2020, 12, 9, 10503-10514.

### SUMMARY

The present disclosure is directed to the use redox materials and coatings that react with PFAS through electrostatic and fluoride-specific interactions, generating concentration-dependent changes in the redox status of these materials. These changes correlate with the type, length, structure, and concentration of PFAS and can be conveniently monitored by spectroscopic and electrochemical means, enabling quantitative detection of these species with low cost methods, e.g. optical spectroscopy and electrochemistry. The invention describes the design and interaction of these materials with a broad class of environmentally-relevant PFAS and their use to create portable sensors for quantitative detection of these chemicals.

The present disclosure is further directed to the use as a low cost portable analyzer that can serve as a fieldable screening tool, complementary to the EPA method for PFAS and related compounds. The technology can be used by communities, industries and organizations to assess PFAS in drinking water and waste streams with greater spatial and temporal resolution. This would enable more effective characterization and management at significantly lower cost.

An aspect of the invention is an assay or apparatus (including a method, test device, test strip, detection kit, sensor) for the visual or electrochemical analysis of PFAS substances in various samples. A further aspect of the invention is a method based on the use of redox indicators as detection probes for PFAS. The indicator component comprises a broad family of compounds including but not limited to: phenazine, coumarin, xanthene, anthraquinone, azo derivatives, benzothiazole phenotriazine, phenoxazine and selenium organic derivatives, or certain metal ions such as silver, copper, cerium, which change the redox properties, color and redox current, in response to the presence of a particular, or a class of PFAS compounds.

According to an embodiment, the redox indicator is incorporated into an ink and printed, or attached to a solid support to construct a device. The device is fabricated by immobilizing or attaching the indicator onto a solid support. Examples of suitable solid supports include but are not limited to paper, ceramics, membrane, packaging materials, polymeric support, cotton swab, patch, test tube, wipe, or sponge, or electrodes such as microelectrodes, 3D printed or screen printed electrodes.

According to an embodiment, the device can be used to determine quantitatively the presence and the relative concentration of PFAS including, but not limited to: Perfluorooctanesulfonate (PFOS), Perfluorooctanoic acid (PFOA), Perfluorobutanoic acid (PFBA), etc.

Another aspect of the invention includes an apparatus for producing signals related to the concentrations of PFAS, wherein the apparatus include an indicator reagent incorporated in a gel, 2D or 3D printed object, electrode or microelectrode.

According to an aspect is a sensor for rapid detection of per and poly-fluoroalkyl substances (PFAS), comprising a conductive composite comprising an indicator incorporated within a working electrode fitted within a tube with a metal wire, and deposited on one of: a sensing surface, microelectrode or a screen-printed electrode; a printed composition of predetermined viscosity and conductivity printed on the working electrode; and a printable ink having deposition and polymerization conditions for printing of standalone sensors with PFAS responsive properties.

According to an embodiment, the conductive composite comprises a redox compound selected from a family comprising: phenazine, coumarin, xanthene, anthraquinone, azo derivatives, benzothiazole phenotriazine, phenoxazine and selenium organic derivatives.

According to an embodiment, the conductive composite comprises a metal complex or nanoparticle from a family comprising: silver, copper, cerium.

According to an embodiment, the sensor further comprises an ink composition for 2D or 3D printing incorporating one of the redox compounds, a polymerizing material, and printing conditions.

According to an embodiment, the ink is printed to fabricate a standalone sensor.

According to an embodiment, the addition of a PFAS compound produces a color change of the printed sensor under varying concentrations of PFAS.

According to an embodiment, the redox compound is deposited onto an electrode surface.

According to an embodiment, the addition of a compound from the PFAS family produces an electrical change under varying concentrations of PFAS.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1A is a schematic showing formation of sensing layer at the surface of a disposable screen-printed electrode (SPE) connected to a portable analyzer, in accordance with an embodiment.

FIG. 1B is a graphical representation showing Differential Pulse Voltammetry (DPV) results showing concentration dependence, in accordance with an embodiment.

FIG. 1C is a schematic and graphical representation showing a Sample analysis approach adding PFAS-containing sample to electrode surface and measurement DPV signal, in accordance with an embodiment.

FIG. 2 is a schematic and graphical representation showing immobilization of a redox indicator, in accordance with an embodiment.

FIG. 3 is a schematic and graphical representation showing an example of electrochemical measurement of PFAS using an indicator, in accordance with an embodiment.

FIG. 4 is a graphical representation of a RAMAN spectra of a PFOS, MDB-PFOS and MBD on a glassy carbon electrode (GCE) after 60 min incubation of PFOS with MBD (pH=6), in accordance with an embodiment.

FIG. 5 are Scanning Electron Microscopy (SEM) Images showing the surface of an electrode: blank (control) and deposited with the indicator before (B) and after reaction with PFOS; shown are images of GCE electrode (A), electropolymerized MB before (B) and after (C) incubation in PFOS, in accordance with an embodiment.

FIGS. 6A-6D are graphical representations of the effect of pH for MDB interacting with PFOS at different pH, PFOS=50 pM (A) with an incubation time for EP-MDB modified electrode in 0.1 M PBS (pH=6) containing 1 nM PFOS (B), UV-Vis measurements at different pH (C) and incubation time (D) MBD=20 uM, PFOS=5 uM at pH=6, in accordance with an embodiment.

FIGS. 7A-7D are graphical representations of changes in electrical current of an electrode modified with the indicator after exposure to different concentrations of PFOS showed by cyclic voltammetry (A) and differential pulse voltammetry (B); linear calibration curve indicating the dependence of normalized current on the concentration of PFOS (C) and the binding isotherm associated to change in current for different concentrations of PFOS (D), in accordance with an embodiment.

FIGS. 8A and 8B are graphical representations of selectivity response of PFOS=50 pM as compared to NaCl and Humic Acid (NaCl 100 nM, HA 100 ppb) (A), and response to different per and poly-fluoroalkyl substances (PFASs) at 50 pM: PFOS, PFOA, PFBS, PFBA (B), in accordance with an embodiment.

FIG. 9 is a graphical representation of Comparison of different cationic dyes in response to PFOS (Meldola Blue—MDB, Methylene Blue—MB, Malachite Green—MG and Thionine—TH), in accordance with an embodiment.

FIGS. 10A-10D are graphical representations of UV-VIS responses and calibration curves to varying concentrations of PFOS using: Methylene Blue (A), Malachite Green (B), Thionine (C) and Safranin O (D), in accordance with an embodiment.

FIGS. 11A-11K are chemical compounds of redox indicators that can be used for the design of the sensors, in accordance with an embodiment.

### DETAILED DESCRIPTION OF EMBODIMENTS

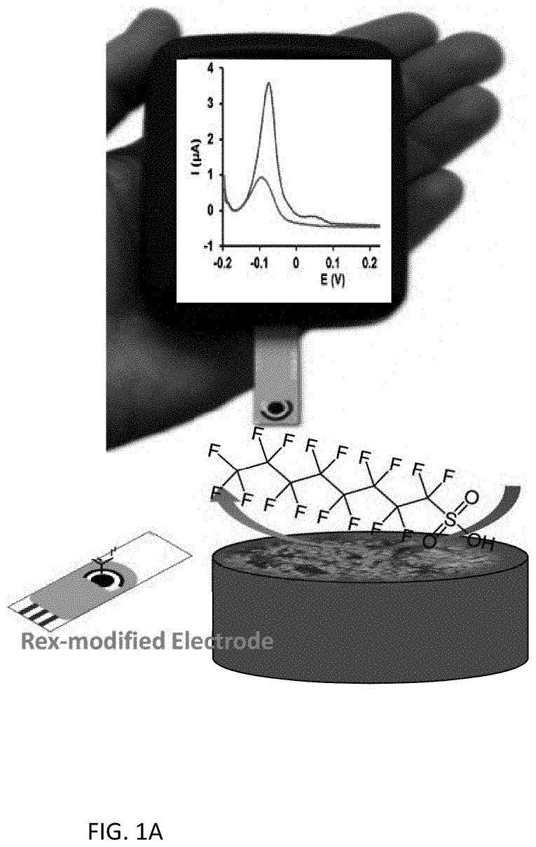

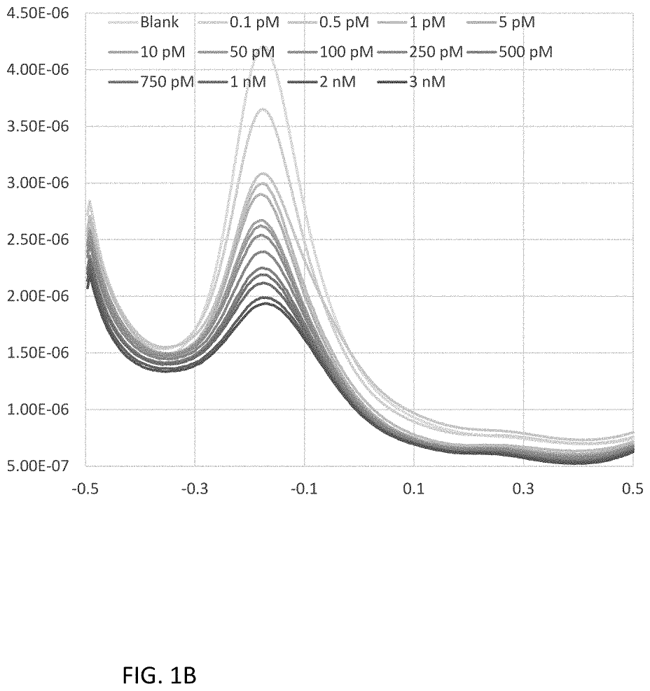

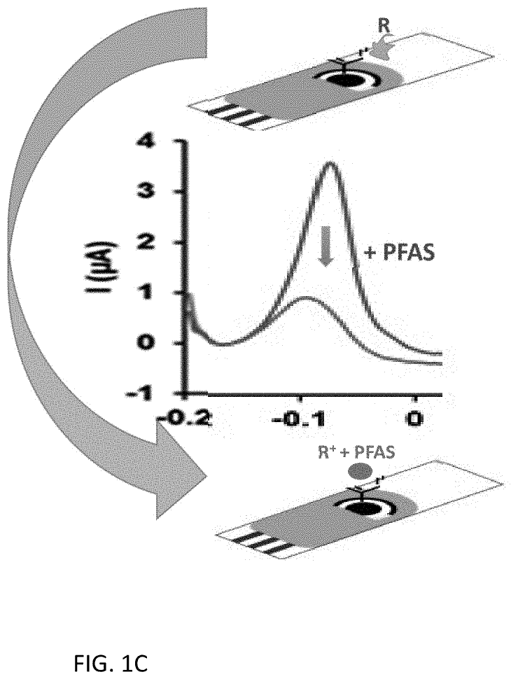

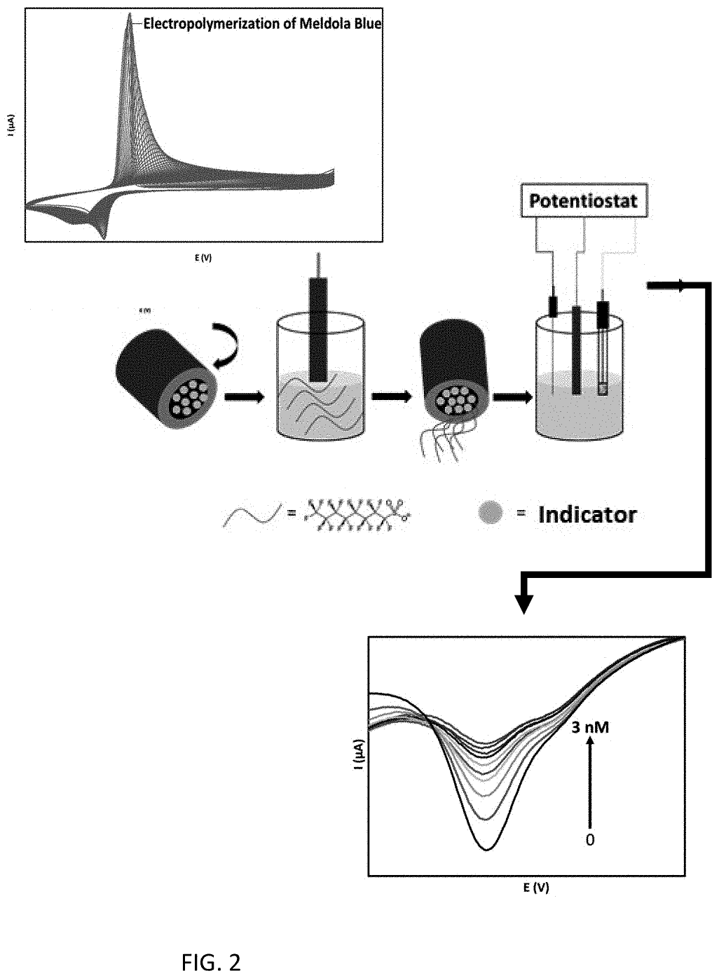

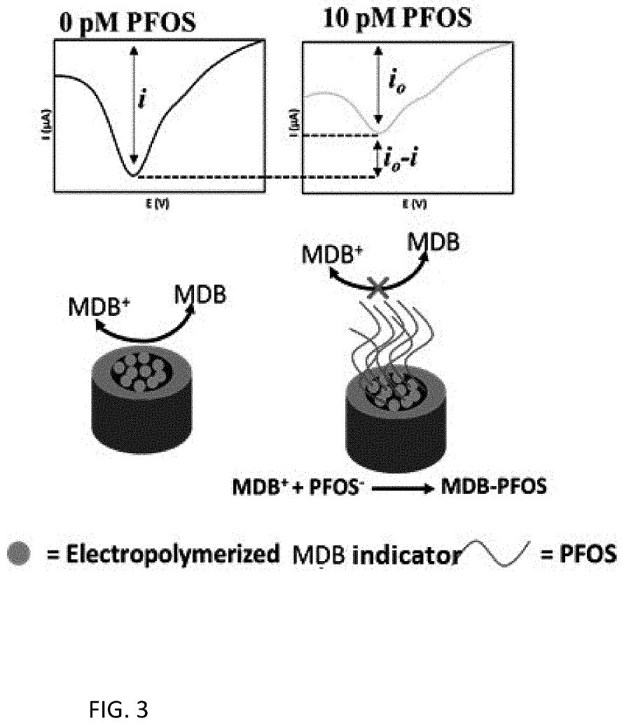

The PFAS detection device described herein is first reporting the use of a redox indicator deposited or printed on the surface of an electrochemical transducer that responds to ppt amounts of PFAS. The present invention takes advantage of the redox changes of the redox indicator as a result of electrostatic and fluoride-specific interactions with a redox dye, monitored using differential pulse voltammetry (FIG. 1). Shown as an example is a sensor with Meldola Blue (MDB) dye, a phenothiazine dye (pKa=6.2), an example of a representative redox indicator from the family of phenoxazine dyes. MDB was immobilized on the electrode surface via electrodeposition (FIG. 2). At pH 6.0, MDB has positively charged quaternary ammonium (MDB+), while PFOS (pKa=−3.7) possesses a negatively charged sulfonic group. The interaction between the amine group of the MBD and the negatively charged PFOS induces a change in the MDB oxidation current in a concentration dependent manner. PFOS− and MDB+ possess several hydrophilic groups under these conditions. When MDB+ reacts with PFOS− a charge neutralization occurs, along with complex formation, also increasing the hydrophobicity and reducing the MDB signal at the electrode surface. These redox changes are very sensitive responding to concentrations as low as 10 pM (FIG. 3).

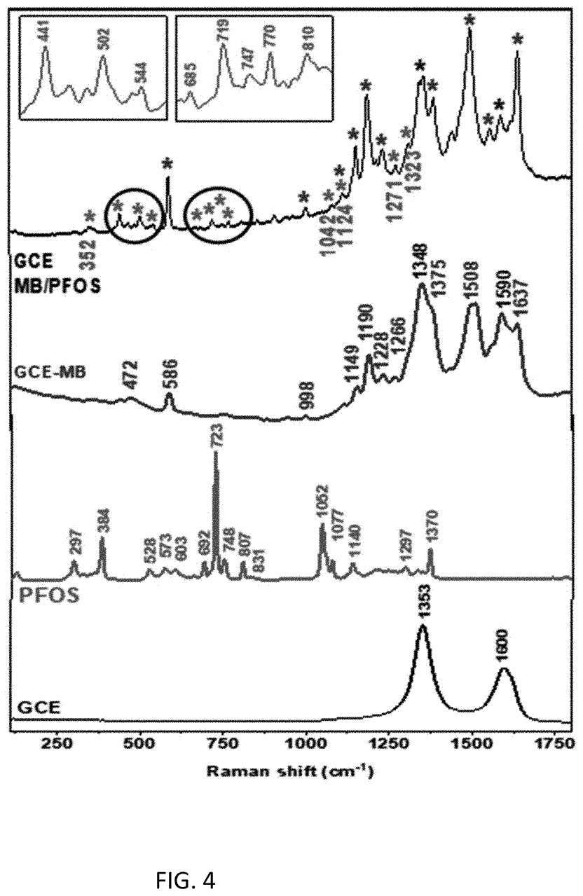

The binding of PFAS to the immobilized MBD studied by Raman and Field-Emission Scanning Electron Microscopy (FE-SEM) shows significant changes in the MBD spectra and molecular structure after interaction with PFAS. PFOS intense peaks are at 297 cm⁻¹ ω(—CF₂), 384 cm⁻¹ δ(—CF₂), 723 cm⁻¹ ν(C—C) and δ(C—C)-coupling of bending and stretching modes in carbon skeleton, CF2 and CF3 groups, 807 cm⁻¹ (carbon skeletal C—C vibrations), 1370 cm⁻¹ (νₘₐₓ(C—F)— neighbor carbon atom stretches in an anti-phase way) and region 1000-1350 cm−1 (different skeletal stretching C—C vibrations coupled with C—F vibrations and sulfonate group bands). After interaction with PFOS, significant changes and shifts in MDB peaks appeared, including redistribution of peaks intensity, broadenings, and shifts of peaks, indicating that PFOS is attaching and altering the MDB structure significantly. Changes occurred in specific spectral regions: 285-450 and 670-840 cm⁻¹ for PFOS and 450-600 cm⁻¹, 1000-1700 cm⁻¹ for MDB. The presence of 352, 384 cm⁻¹ lines and a set of bands situated in the 670-840 cm⁻¹ region (685, 719, 747, and 810 cm⁻¹) indicates the presence of PFOS on MDB modified electrodes (FIG. 4).

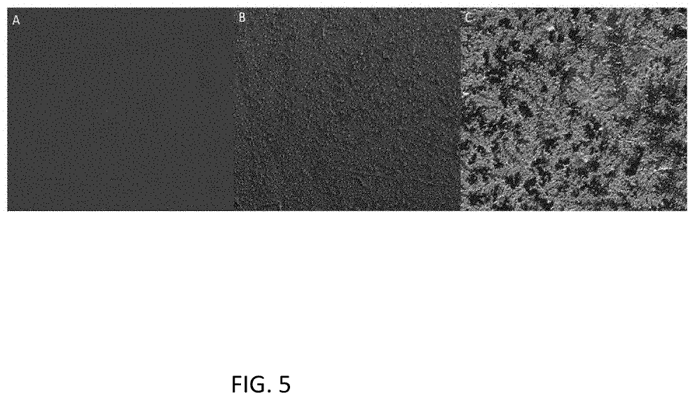

The morphology and elemental analysis performed by FE-SEM with energy dispersive X-Ray analysis (EDX) shows significant modification in the MBD structure after interaction with PFOS (FIG. 5). A uniform and smooth layer of MBD covers the surface of the electrode. After incubation in PFOS, the surface changes to a cluster-like structure due to increased hydrophobicity and charge neutralization by MBD, confirming the strong interaction between the MBD and PFOS. A study of the scan rate found that the square root of scan rate is proportional to the redox peak currents indicating a diffusion-controlled process of the PFOS detection at the modified sensor. PFOS first diffuses to the MBD electrode where binding occurs. This is followed by a surface-confined process until all binding sites on the surface are occupied by PFOS preventing the MBD from taking part in the redox process.

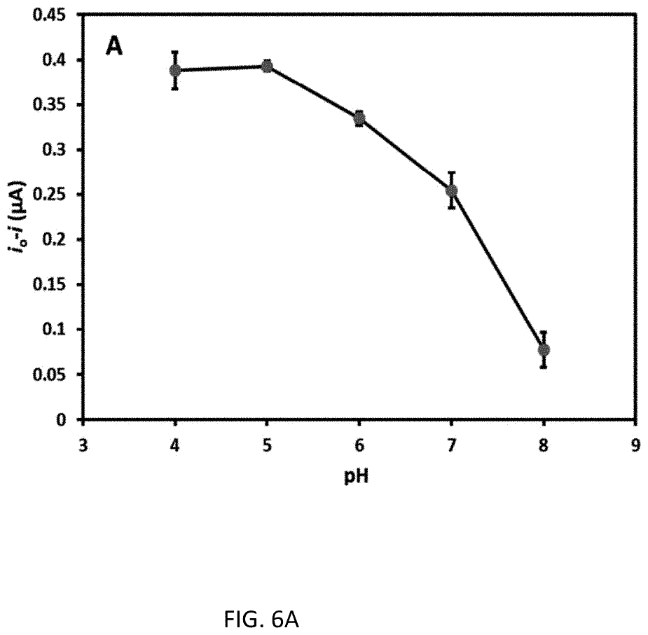

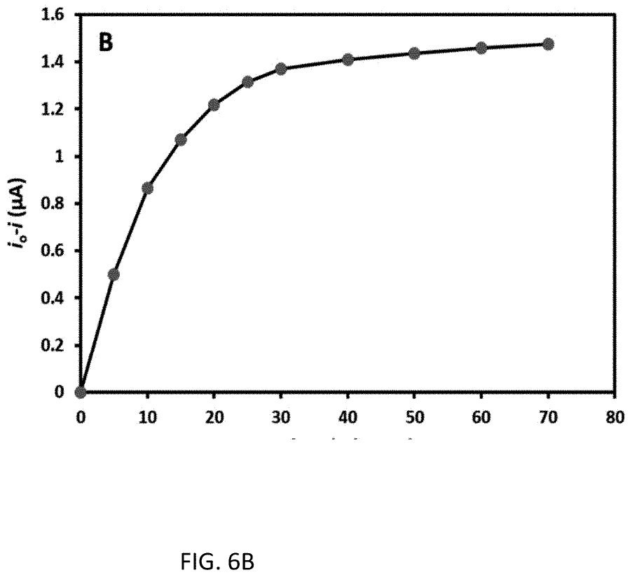

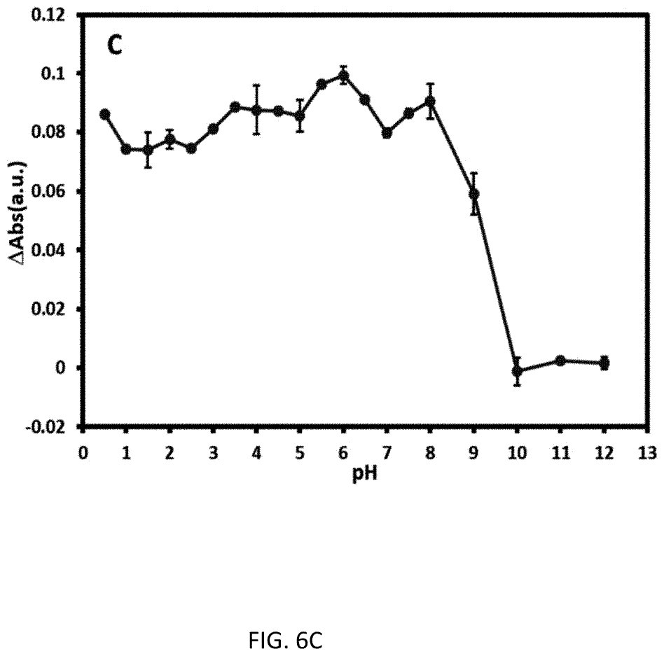

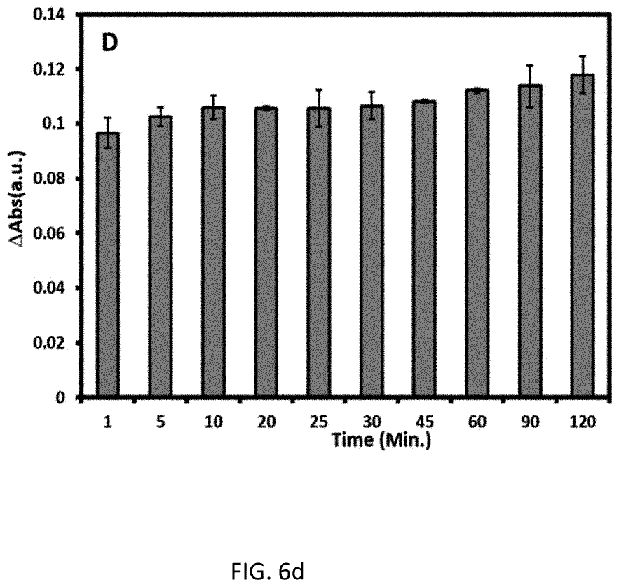

PFOS measurements can be performed over a range of pH, with higher signals being obtained at pH values below 7 (FIG. 6) covering the useful pH range in environmental systems. The incubation time required for the sensor to provide measurements are as little as 1-5 min for MBD in solution to 20-25 min for the immobilized MBD. The time necessary for the PFAS to bind to redox indicator can vary with the different materials used to immobilize the indicator, stabilizing agents and the type of electrode used. For the electropolymerized MBD on a GCE electrode, an incubation time of 25 min provided quantification of as little as 1 nM PFOS.

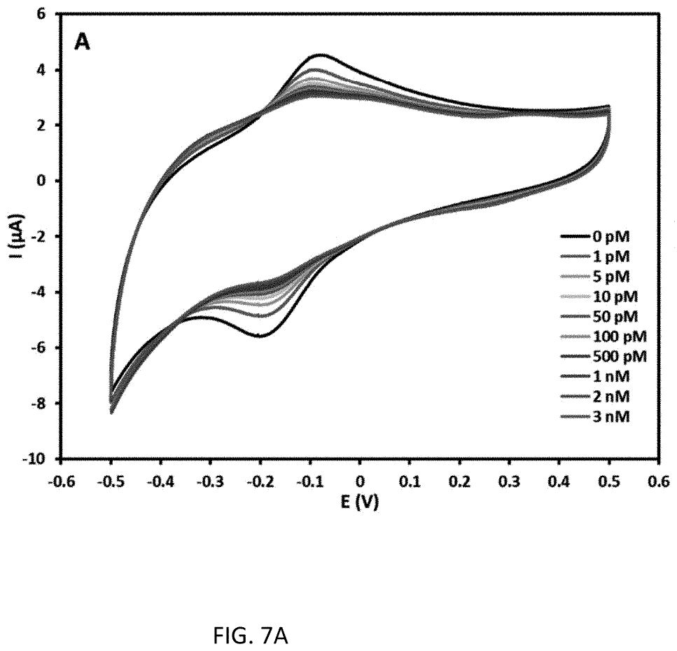

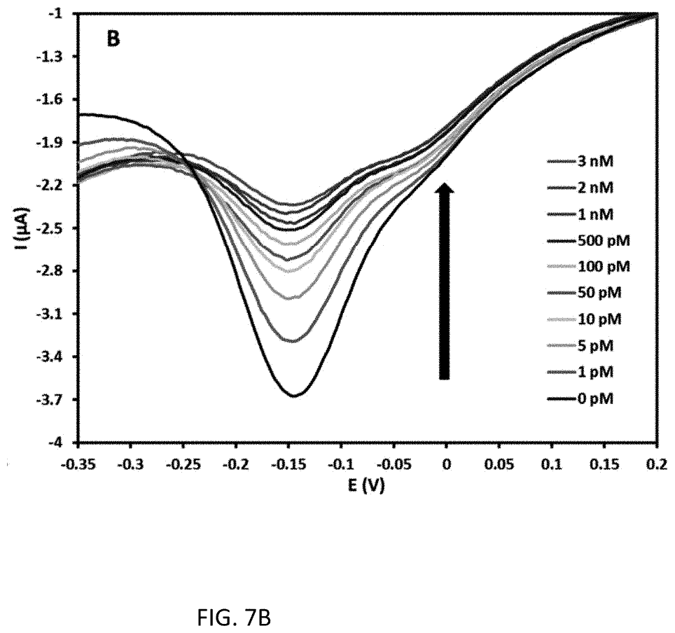

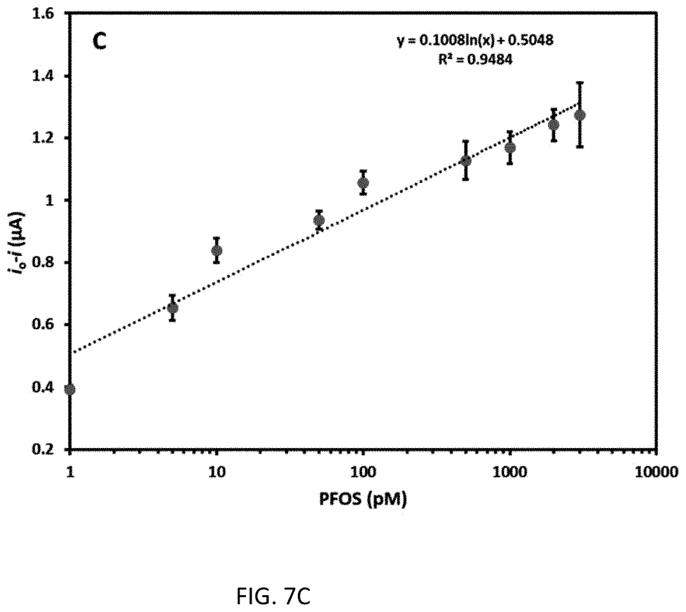

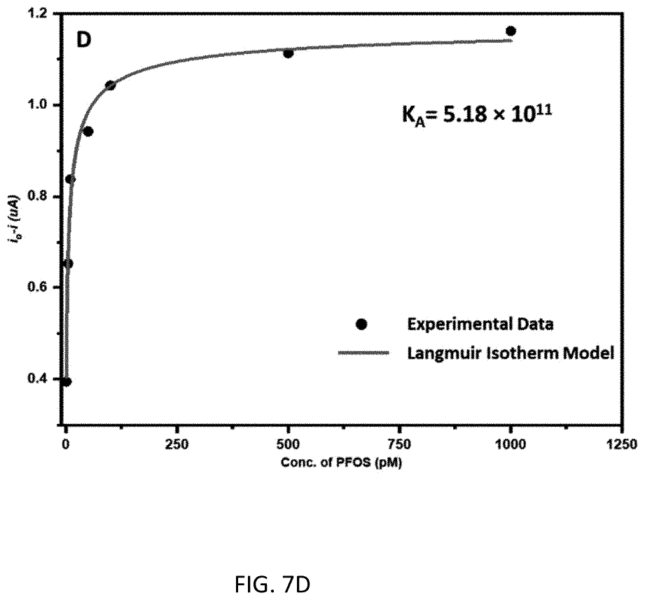

Quantitative analysis of PFAS compounds by electrochemistry is best performed using Differential PulseVoltammetry (DPV) (FIG. 7), which shows a decreased current with the increase in the concentration of PFOS. The relation between the MBD current and PFOS concentration, or calibration curve extracted from DPV data shows a linear fit with the concentration. The linear fit ranges from 1 pM to 3 nM with a limit of detection (3σ/m) of 0.8 pM and a limit of quantification is 2.1 pM (10 σ/m). Using the Langmuir isotherm model to calculate the binding sites (Equation 1), an association constant K_{A} of 5.18×10¹¹ M⁻¹ was found for PFOS, indicating strong interaction between the MBD and PFOS.

$${i}_{o} - i = \frac{{B}_{max} \times C \times {K}_{A}}{1 + ( C \times {K}_{A} )} \qquad Equation ( 1 )$$

where Bmax is maximum binding capacity, C is the concentration of PFOS, K_{A} is the constant.

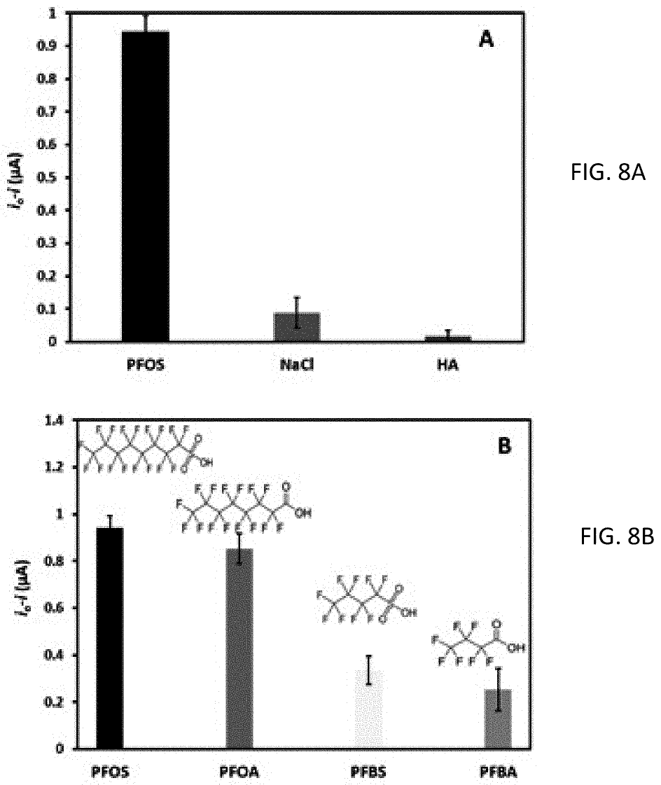

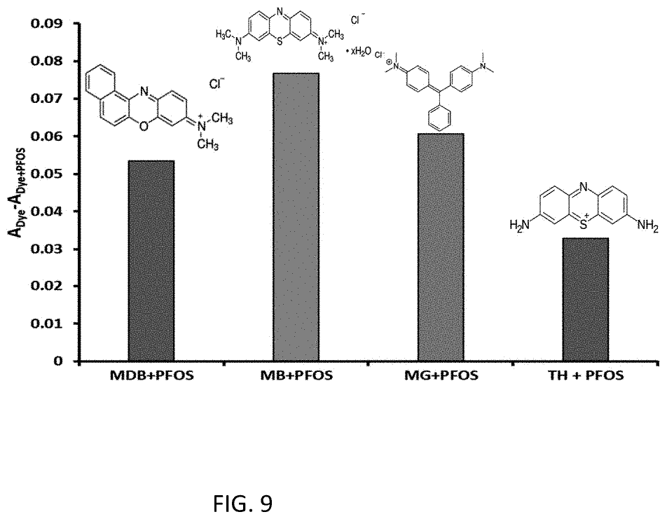

The sensor is selected towards PFASs compounds and shows no response to interferents commonly found in water such as humic acid and sodium chloride (FIG. 8). The sensor can detect varying classes of perfluoroalkyls; longer chains PFAS show higher response than smaller chain compounds (FIG. 9). Variabilities in the PFAS structure and chain length is seen as a change in the current intensity, or other characteristics of the redox indicator. One of ordinary skill in the art would recognize that variations in the characteristics of the PFAS will likely have some effect on the redox indicator. Pattern recognition techniques can be used to differentiate between different classes of compounds and categorize PFAS based on differences in the sensor response. The response to PFAS can be measured with conventional electroanalyzers. Portable analyzers connected to a cellphone can also be used allowing for low cost measurements directly in the field.

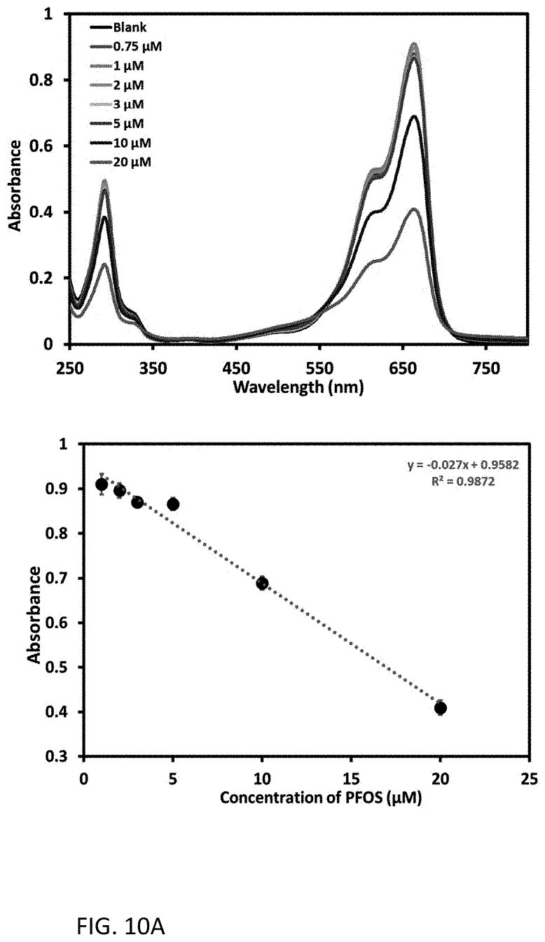

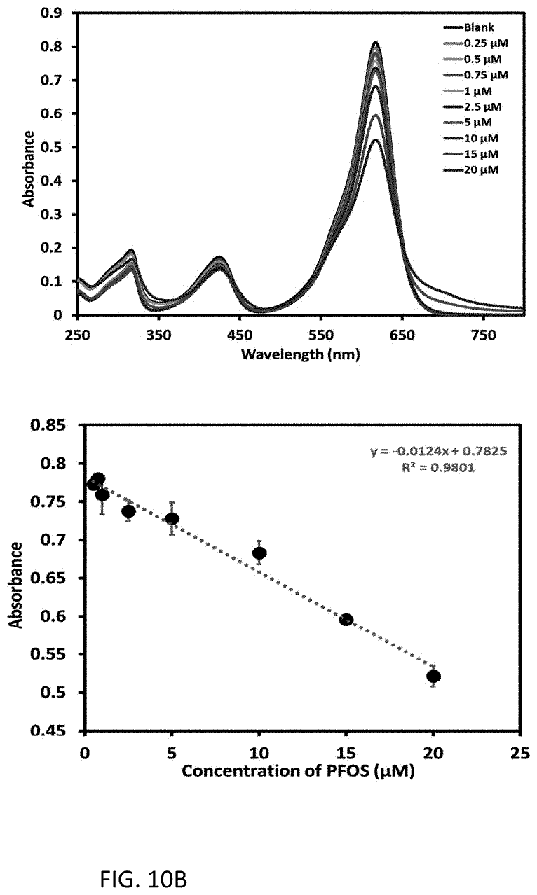

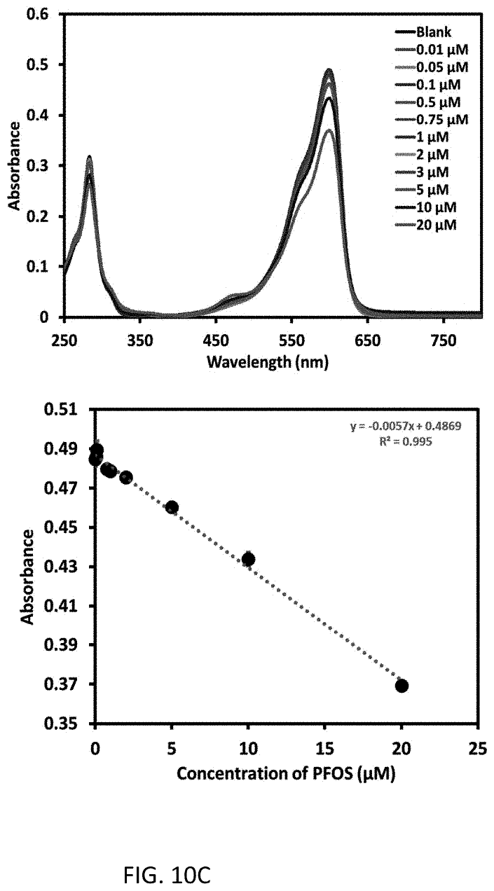

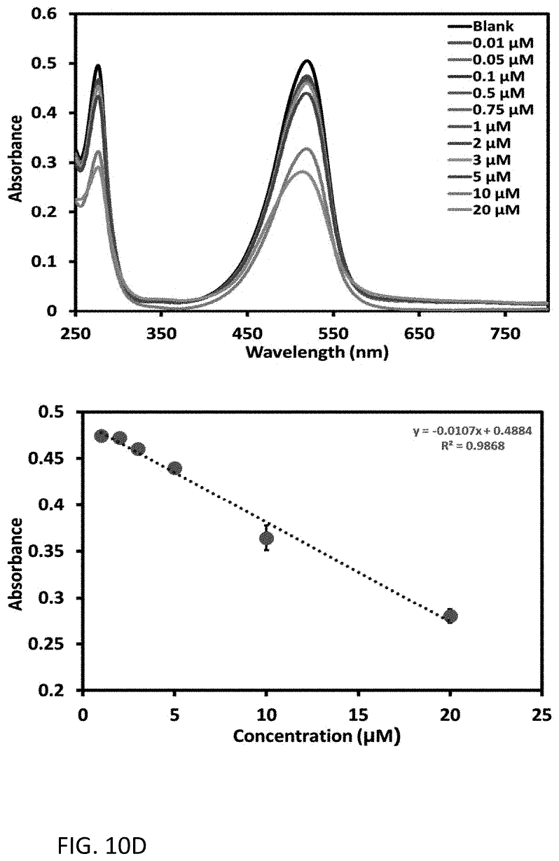

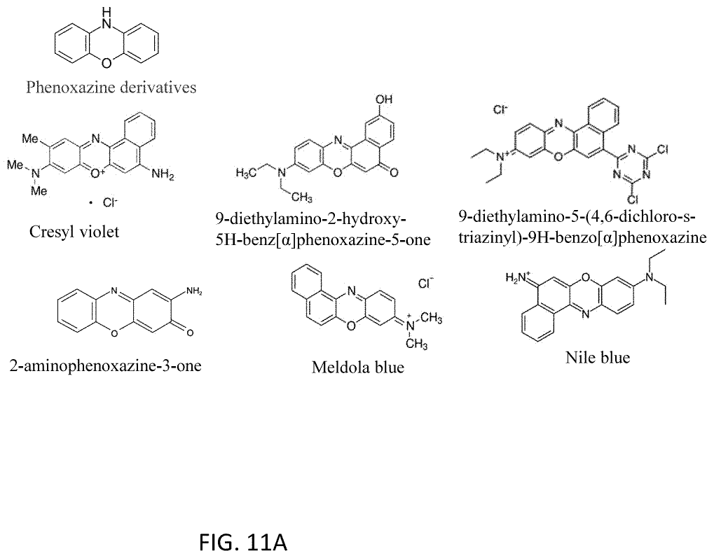

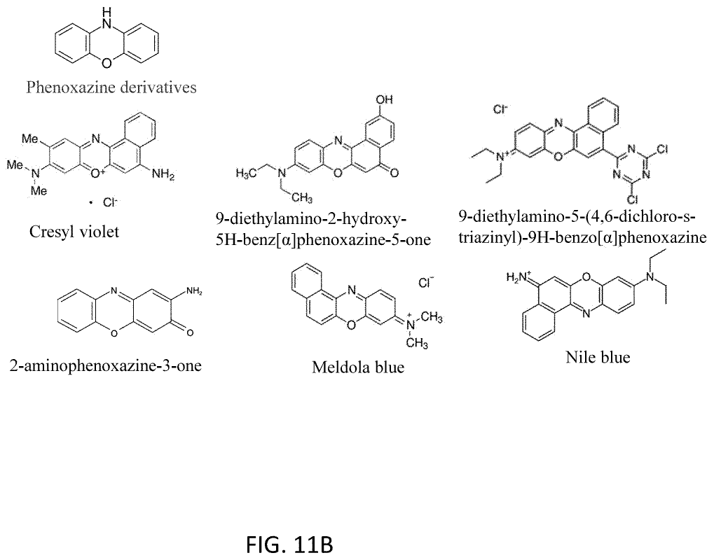

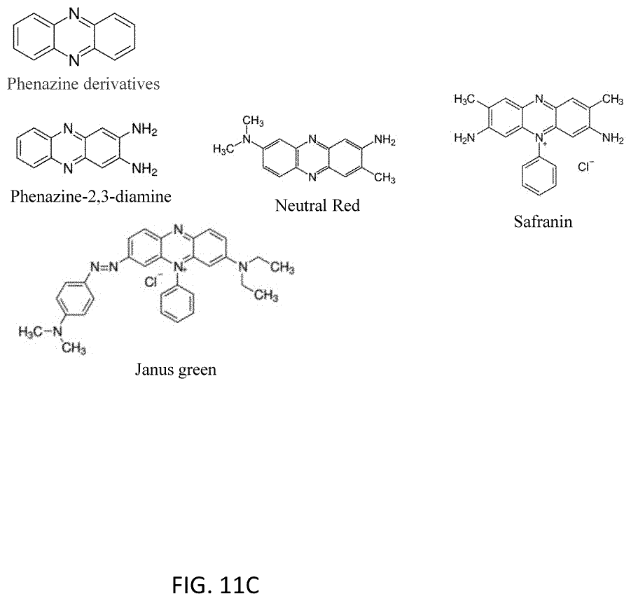

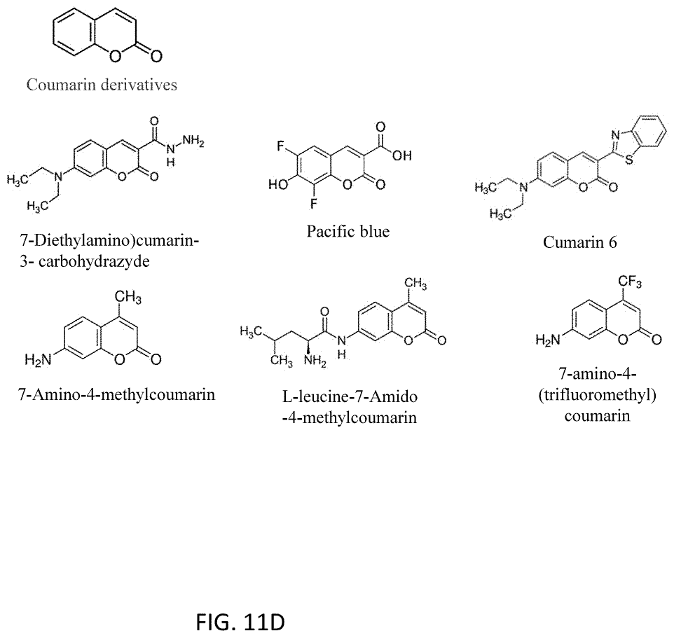

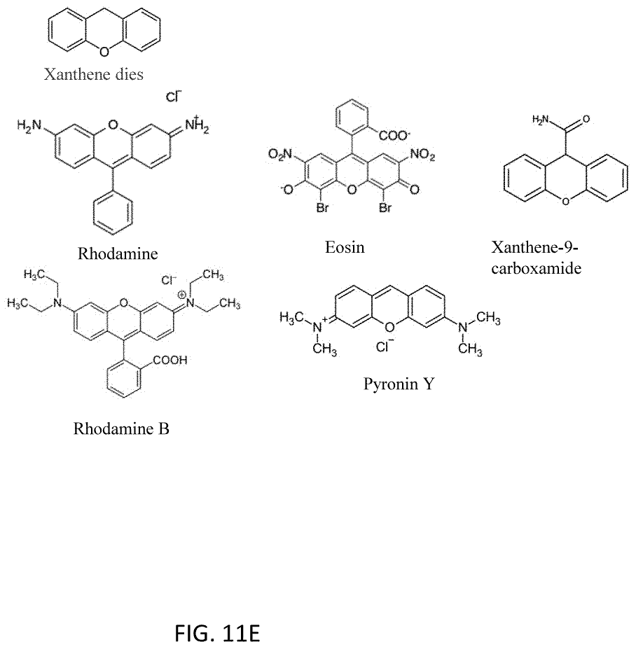

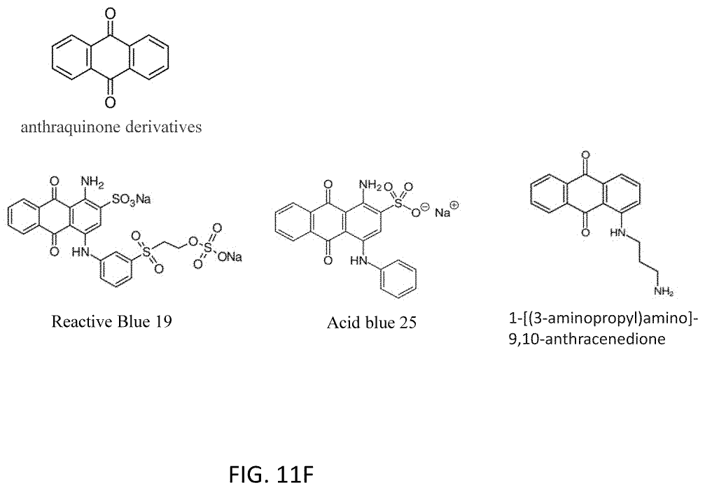

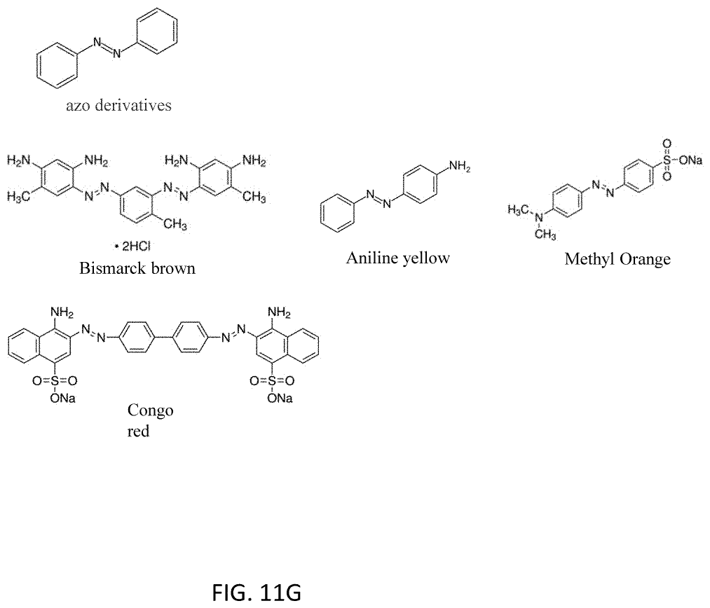

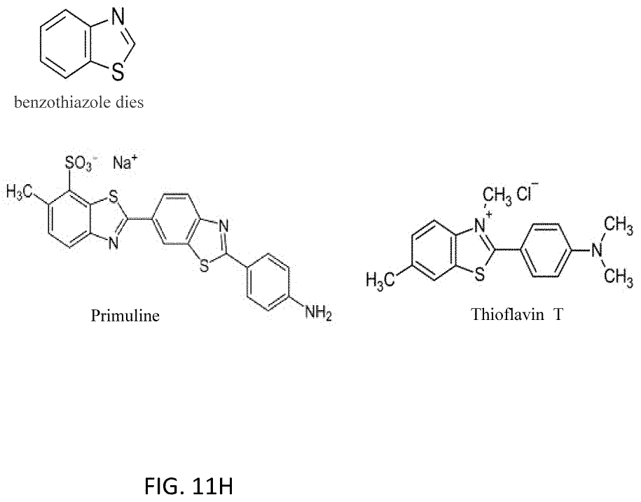

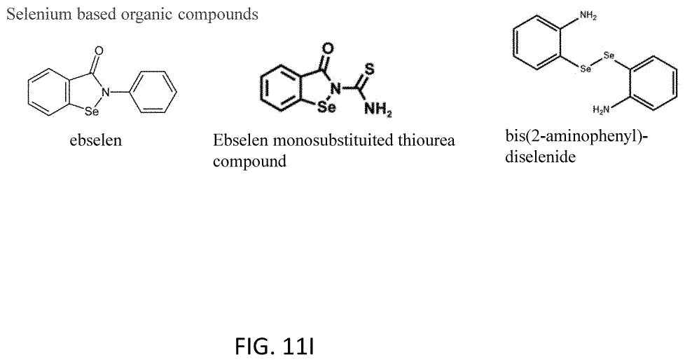

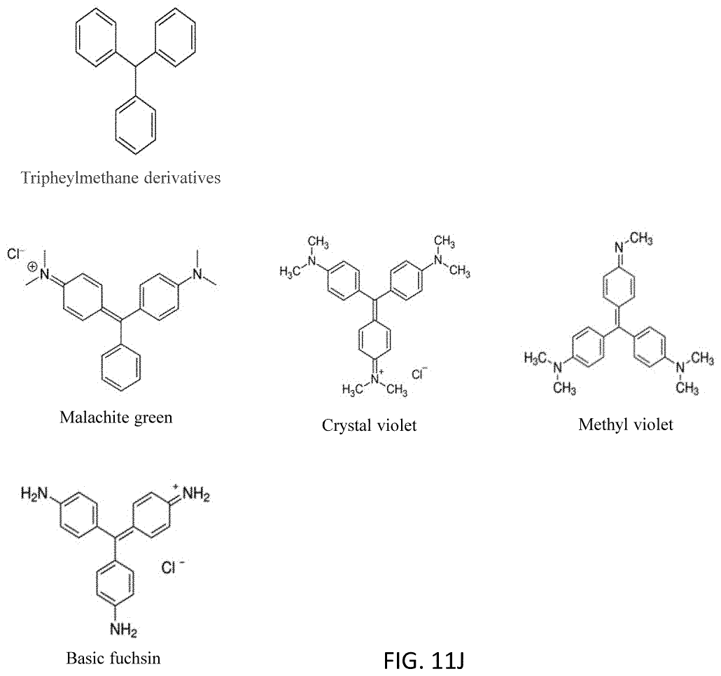

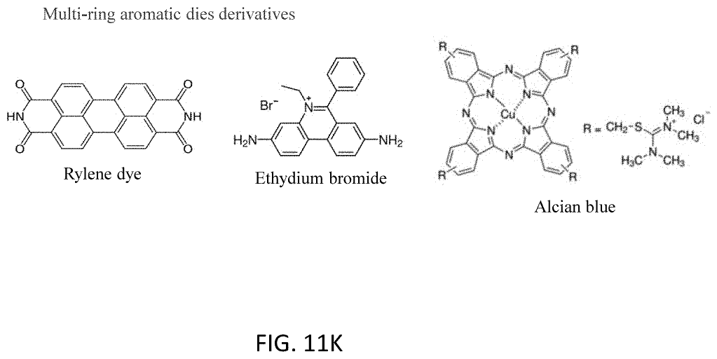

The aspect described above is not limited to any one indicator, or only MBD. Further, the aspect described above refers to different types of redox indicators such as Methylene Blue, Malachite Green, Thionine and Safranin O, all of which have the ability to bind and change the redox signature in response to PFAS in a concentration dependent manner as showed in FIG. 10. Redox indicator refers to redox compounds such as Methylene Blue, Malachite Green, Thionine and Safranin O, and cover examples listed in FIG. 11A-11K. For such applications, the materials described herein can be used in solution or immobilized onto solid supports. Both optical and electrochemical detection systems can be used. Examples of solid supports are: paper, electrodes, glass, etc.

An example of test device in the present invention, in a very simple form is shown in FIG. 1 where a screen printed electrode is used, modified with the redox indicator for the electrochemical based detection. The response of the indicator is recorded before (i) and after (io) incubation in PFOS solutions. This process is used as a basis for fabrication of a test strip or electrode for PFAS detection. The redox indicator is either electrodeposited or deposited in a composite form using a polymeric or a silica-gel linker, and can contain stabilizing agents, additives; it can also be covered with stabilizing layers of polymers, hydrogels, porous silica-gels, etc. Variables in the electrode and electrode materials used to immobilize the redox indicator can result in variable outcomes. For example, the use of silica sol-gel to stabilize the indicator could increase stability and increase the incubation time. Variables in the type of the electrode can provide different linearity ranges and detection limits. The use of carbon fiber microelectrodes as working electrode for example can provide lower detection limits. One of ordinary skill in the art would recognize that variations in the characteristics of the electrode material will likely have some effect on the interactions and chemical reactions described herein.

An example of sensing surface comprise an ink containing the redox material that is deposited by printing. The ink may contain a polymeric material (e.g. conductive polymers like pyrrole or aniline or biopolymers like chitosan, alginate, gelatin), or sol-gel silica matrices, in addition to the redox indicator from the list in FIGS. 11A-11K. The ink can be 2D or 3D printed on a solid platform such as a screen printed electrode or as a standalone construct to create the sensor. The aspects described above apply to any system in which redox indicators are printed or deposited for measuring PFAS through spectroscopic or electrochemical methods. This process is cost effective and salable and can produce large numbers of sensors rapidly and with a high degree of reproducibility.

### Applications

There are many applications of this invention. The disclosed device is particularly suitable for on-site detection of broad-spectrum of PFAS in any applications involving samples containing PFAS. These include but are not limited to environmental applications to test presence and concentration of PFAS in water (drinking/tap water, waste water), food and clinical (e.g. blood, urine) samples. The particular materials, type of samples, amounts thereof, products, physical testing equipment in these examples, as well as other conditions and details, are to be interpreted to apply broadly in the art and should not be construed to unduly restrict or limit the invention in any way.

A portable electrode for determining PFAS to assess remediation efficiency.

Used here to illustrate the concept is a disposable electrode to evaluate the effectiveness of a PFAS treatment/destruction, in support of ongoing remediation efforts. For example, the sensor can be used to determine PFAS content in a waste stream before and after treatment, speeding the analytical process to evaluate cleanup efficiency. The process is estimated to reduce testing costs by about 80%.

A portable test strip for determining PFAS contamination in tap and drinking water.

A screen printed electrode or a printed strip prepared from an ink containing the PFAS-responsive redox indicator is used to assess levels of PFAS in drinking and tap water, reducing the time and cost required by conventional laboratory-scale technologies.

A ultrasensitive carbon fiber microelectrode with immobilized MBD for PFAS analysis in blood or urine samples.

Used here to illustrate the concept is a carbon fiber microelectrode functionalized with a redox indicator, e.g. MBD, electroplymerized or immobilized within a solids sol-gel. The sensor is used to provide a rapid test of total PFAS in biological fluids. These tests can be used by health professionals to determine concentrations and understand PFAS exposure.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A sensor for rapid detection of per and poly-fluoroalkyl substances (PFAS), comprising:
a. a conductive composite comprising an indicator incorporated within a working electrode fitted within a tube with a metal wire, and deposited on one of: a sensing surface, microelectrode or a screen-printed electrode;
b. a printed composition of predetermined viscosity and conductivity printed on the working electrode; and
c. a printable ink having deposition and polymerization conditions for printing of standalone sensors with PFAS responsive properties.

2. The sensor of claim 1 wherein the conductive composite comprises a redox compound selected from a family comprising: phenazine, coumarin, xanthene, anthraquinone, azo derivatives, benzothiazole phenotriazine, phenoxazine and selenium organic derivatives.

3. The sensor of claim 1 wherein the conductive composite comprises a metal complex or nanoparticle from a family comprising: silver, copper, cerium.

4. The sensor of claim 2 comprising an ink composition for 2D or 3D printing incorporating one of the redox compounds, a polymerizing material, and printing conditions.

5. The sensor of claim 4 wherein the ink is printed to fabricate a standalone sensor.

6. The sensor of claim 5 wherein the addition of a PFAS compound produces a color change of the printed sensor under varying concentrations of PFAS.

7. The sensor of claim 2 wherein the redox compound is deposited onto an electrode surface.

8. The sensor of claim 10 wherein the addition of a compound from the PFAS family produces an electrical change under varying concentrations of PFAS.
